(19) United States
(12) Patent Application Publication
(10) Pub. No.: US 2018/0043967 A1
(43) Pub. Date: Feb. 15, 2018

(54) Motorcycle Engine Mount having Improved Stiffness and Exchangeability

(71) Applicant: Jeremy Ore, Ramona, CA (US)

(72) Inventor: Jeremy Ore, Ramona, CA (US)

(21) Appl. No.: 15/674,391

(22) Filed: Aug. 10, 2017

Related U.S. Application Data
(63) Continuation-in-part of application No. 14/634,227, filed on Feb. 27, 2015, now abandoned.

(51) Int. Cl. B62M 7/02

(52) U.S. Cl. CPC B62M 7/02

(57) ABSTRACT

A Motorcycle Engine Mount having Improved Stiffness. The device is a bolt-in replacement for the Original Equipment Manufacturer engine mounts for FXD_ series Harley Davidson motorcycles. The device has a single-piece, hardened steel outer frame, and a interstitial formed from urethane (rather than rubber) having a durometer reading of approximately 80. Unlike the device of the Parent Application, the urethane interstitial element is not bonded to the outer frame element so that the urethane interstitial element can be slid out of the outer frame and replaced, if desired. The interstitial element protrudes from the outer frame, and does not reach the full depth of the outer frame depth.

This application is a continuation of application Ser. No. 14/634,227, filed Feb. 27, 2015, now pending (hereinafter “the Parent Application”).

### BACKGROUND OF THE INVENTION

### 1. Field of the Invention

This invention relates generally to motorcycle frame and mounting components and, more specifically, to a Motorcycle Engine Mount having Improved Stiffness and Exchangeability.

### 2. Description of Related Art

The popularity of motorcycling continues to increase. Riders are attracted to the freedom of the open road, leaving behind the cares and worries of everyday life. Motorcycle manufacturers have seized upon the recent surge in popularity and continue to sell motorcycles and accessories in record numbers.

However, statistics show that motorcycles are generally more dangerous than automobiles. Two prior patents granted to Jake Ore (U.S. Pat. Nos. 7,967,097 and 8,387,737) address the issue with Harley Davidson¹ motorcycles commonly referred to as a “high-speed wobble” (or “tank-slapper”), which typically involves shaking or instability. This wobble can cause the front wheel can thrash from side to side in an uncomfortable and unsafe manner. The devices and methods of the '097 and '737 patents cured the high-speed wobble on the “FLH” series of Harley Davidson motorcycles (known as the “Electra Glide,” “Road King,” and “Ultra Classic). ¹ The Specification may include references to third-party trademarks, and copies of third-party copyrighted materials, which are the property of their respective owners, including H-D U.S.A., LLC. Reference to any product, process, publication, service, or offering by trade name, trademark or otherwise is not intended to constitute or imply the endorsement or recommendation of such by Harley-Davidson. “Wide Glide,” “Electra Glide,” and “Road King” trademarks are believed to be the property of H-D U.S.A., LLC.

It has been determined that two other models Harley Davidson—the “Wide Glide” and “Ultra Glide” (the “FXD_” series), suffer from a very similar problem. Because the FXD_ series bikes employ a different mounting system as compared to the FLH series bikes, the two prior Ore devices were unable to solve the high speed wobble on these models of motorcycles.

Therefore, there remains a need to overcome the problem of instability in FXD_ series HarleyDavidson motorcycles. The discussion of the background to the invention included herein is included to explain the context of the invention. This is not to be taken as an admission that any of the material referred to was published, known, or part of the common general knowledge at the priority date of the claims.

### SUMMARY OF THE INVENTION

In light of the aforementioned problems associated with the prior devices, it is an object of the present invention to provide a Motorcycle Engine Mount having Improved Stiffness. The device should be a bolt-in replacement for the Original Equipment Manufacturer engine mounts for FXD_ series Harley Davidson motorcycles. The device should have a single-piece, hardened steel outer frame, and a interstitial formed from urethane (rather than rubber). Unlike the device of the Parent Application, the urethane interstitial element should not be bonded to the outer frame element so that the urethane interstitial element can be slid out of the outer frame and replaced, if desired. The interstitial element should protrude from the outer frame, and should not reach the full depth of the outer frame depth.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of the Harley Davidson FXD_{—} series frame and engine mount assembly²; ² Taken from the 2007 Harley Davidson Shop Manual; used for educational purposes only; all rights believed owned by Harley Davidson, Inc.

FIG. 2 is a front perspective view of the conventional engine mount element for an FXD_{—} series motorcycle;

FIG. 3 is a rear perspective view of the engine mount element of FIG. 2;

FIG. 4 is a front perspective view of the Engine Mount having Improved Stiffness of the Parent Application;

FIG. 5 is a rear perspective view of the element of FIG. 4;

FIGS. 6A and 6B are front perspective views the Improved Engined Mount having Improved Stiffness and Exchangeability;

FIG. 7 is a side view of the Mount element of FIGS. 6A and 6B;

FIG. 8 is an exploded rear perspective view of the Mount element of FIGS. 6A and 6B; and

FIG. 9 is a rear perspective view of the Mount element of FIGS. 6A and 6B.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Motorcycle Engine Mount having Improved Stiffness and Exchangeability³. ³ As used throughout this disclosure, element numbers enclosed in square brackets [ ] indicates that the referenced element is not shown in the instant drawing figure, but rather is displayed elsewhere in another drawing figure.

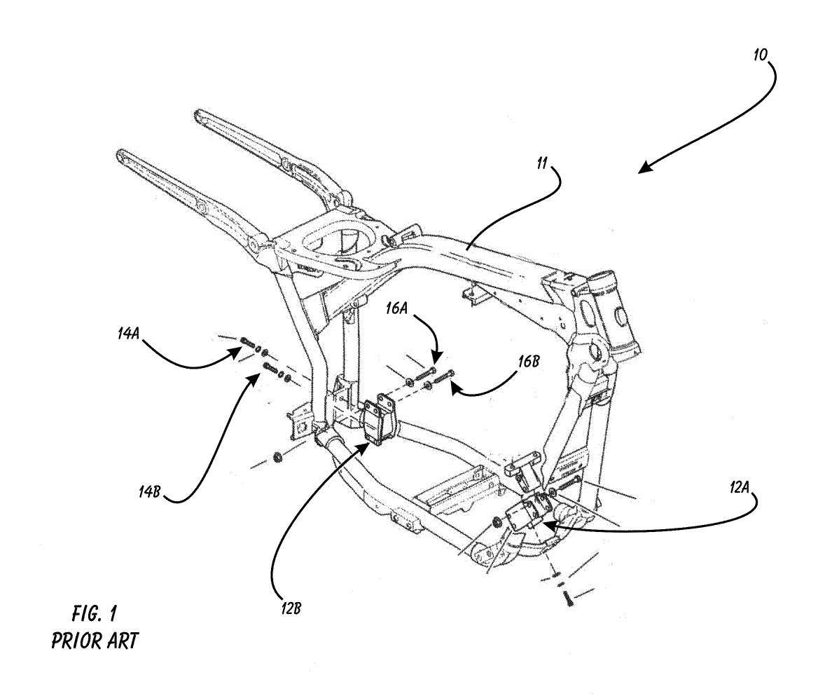

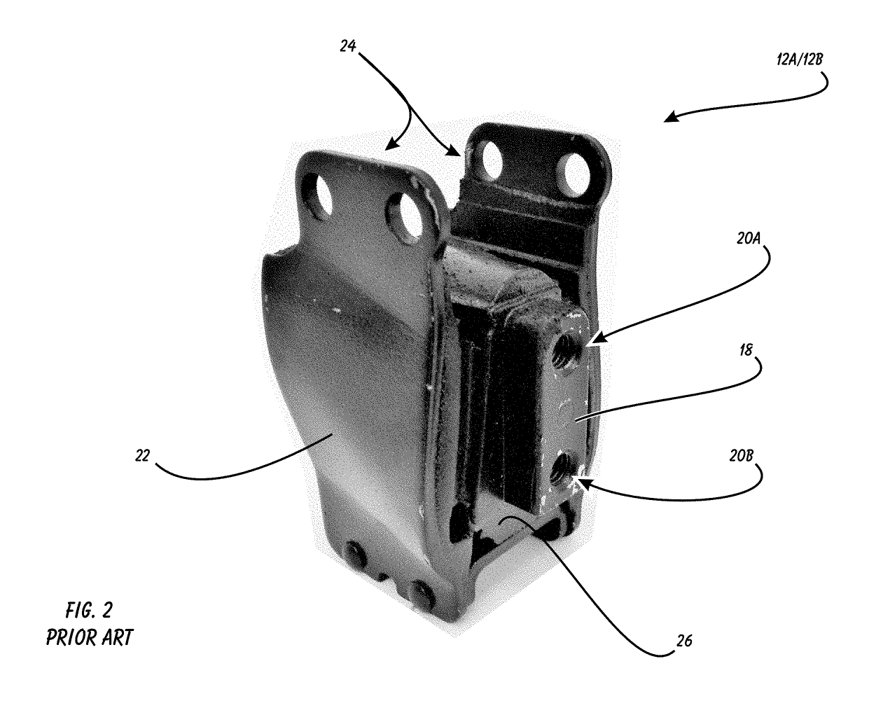

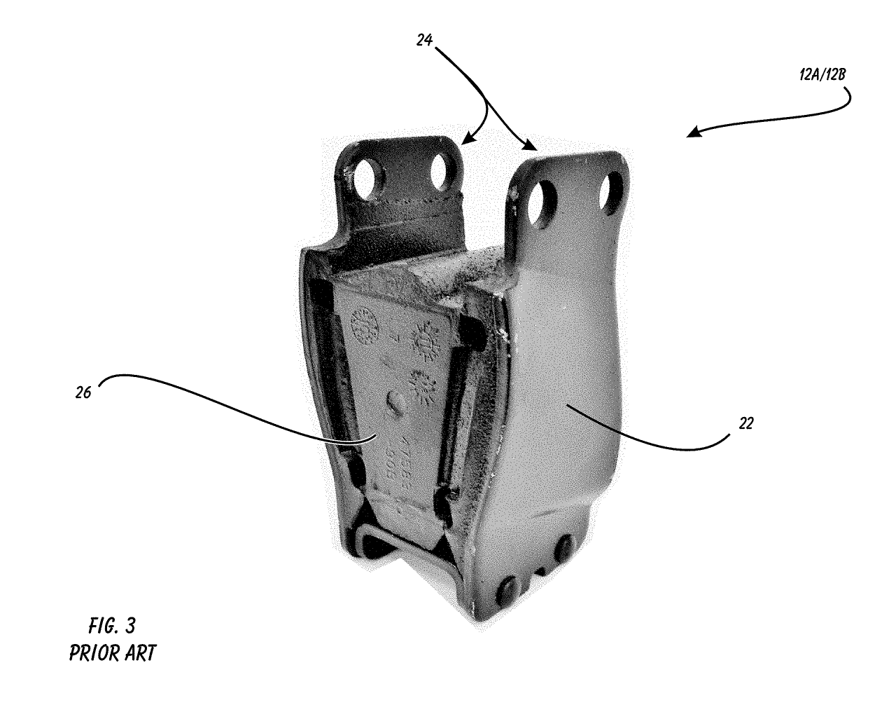

We will begin the description of the invention by first examining the features of the prior art Harley Davidson FXD_{—} series motorcycle. FIG. 1 is a perspective view of the Harley Davidson FXD_ series frame and engine mount assembly 10. In order to isolate and dampen the vibrations generated by the running engine, the engine (not shown) is linked to the frame 11 by a pair of engine mount elements 12A, 12B. Each mount 12A, 12B attaches to the frame 11 by a pair of frame bolts 14A, 14B (only shown for the rear engine mount element 12B). The engine (not shown) then attaches to each of the mounts 12A, 12B by a pair of engine bolts 16A, 16B. As will be discussed in connection with FIGS. 2 and 3, there is a rubber portion separating the frame bolts 14A, 14B from the engine bolts 12A, 12B. It is this rubber (provided for vibration dampening) that is insufficiently stiff, and therefore allows for unacceptable amounts of wobbling or shaking in the motorcycle under certain riding conditions.

FIG. 2 is a front perspective view of the conventional engine mount element 12A, 12B for an FXD_{—} series Harley Davidson motorcycle. The outer structure is an engine attachment frame 22. This frame 22 is made from stamped steel, presumably for its durability. In this version, there are three individual pieces of stamped steel that have been riveted together. Captured inside of the engine attachment frame 22 is a frame attachment base 18. The frame attachment base 18 has a pair of threaded bolt bores 20A, 20B formed within it. These bores 20A, 20B are adapted to accept the frame bolts [14A, 14B] within them when the mount element 12A/12B is attached to the frame [11].

The engine bolt bores 24 are provided to accept engine bolts [16A, 16B] through them as they pass through corresponding bores formed in the engine (for mounting the engine to the mounting element 12A, 12B.

The problem area with the conventional engine mount elements 12A, 12B, lies with the rubber interstitial element 26. This rubber “fills” the gap between the engine attachment frame 22 and the frame attachment base 18. The rubber interstitial element 26 serves to prevent vibrations from being transmitted between the frame attachment base 18 and the engine attachment frame 22. By design, the rubber element 26 also secures and supports the frame attachment base 18 within the engine attachment frame 22. The rubber interstitial element 26 “sticks” to the engine attachment frame 22 in some fashion, but this interconnection has been found to be unreliable.

The problem with the conventional mount elements 12A, 12B is that after very little time in service, this rubber interstitial element 26 becomes pliable and the frame attachment base 18 is no longer held securely within the engine attachment frame 22. The movement allowed between these elements results in a loose connection between the engine and the frame [11], which causes the wobbling under many riding conditions.

FIG. 3 is a rear perspective view of the engine mount element of FIG. 2. This view is provided to illuminate the fact that the back of the frame attachment base [18] does not protrude through the rubber interstitial element 26, but rather is fully encased in rubber (on three sides). As will be discussed below, this design error has been corrected with the device of the present invention.

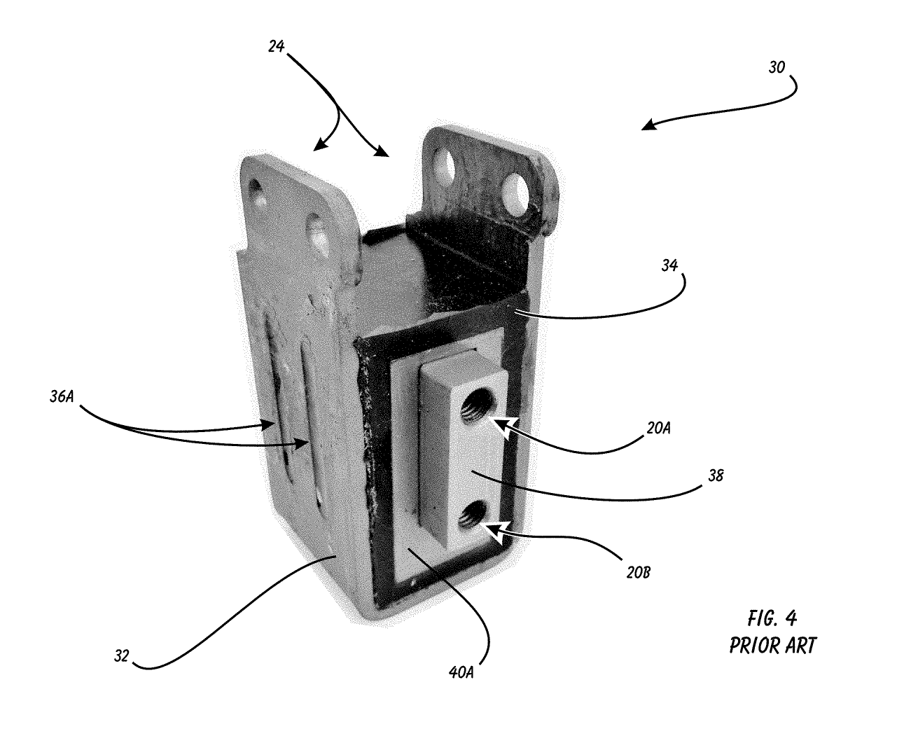

FIG. 4 is a front perspective view of the Engine Mount having Improved Stiffness of the Parent Application. Of course, the improved mount element 30 is designed to fit the frame [11] perfectly as a replacement for the conventional mounts [12A, 12B]. It is there that the similarities end between the two designs, as will become clearer below.

The improved mounting element 30 has a one-piece engine attachment frame 32. It is formed from a single piece of hardened steel in order to ensure that there is virtually no degradation (i.e. deformation) after prolonged service time. The frame attachment element 38 protrudes from the mount element 30 just as with the prior design, and furthermore has the pair of threaded frame bolt bores 20A, 20B formed within it.

The interstitial element 34 in this mount 30 is made from a high quality urethane, instead of the rubber material used in the prior design. The urethane material 34 has superior wear performance as compared to rubber (i.e. it remains stiff much longer), and this particular urethane has been selected to have a durometer reading (A scale) of between 40 and 60 (A scale). It is preferred that the front mount [12A] urethane have a 45 durometer reading, and the rear mount [12B] urethane have a 55 durometer reading.

Two key additional features can be seen in this view—first, the engine attachment frame 32 is formed with retaining apertures 36A formed in it (there are actually five in the entire frame 32). Each retaining aperture (e.g. 36A) is designed to allow the urethane forming the interstitial material 34 to push out and fill in the aperture 36A. Once cured, this protruding material will form a secure bond between the interstitial element 34 and the engine attachment frame 32.

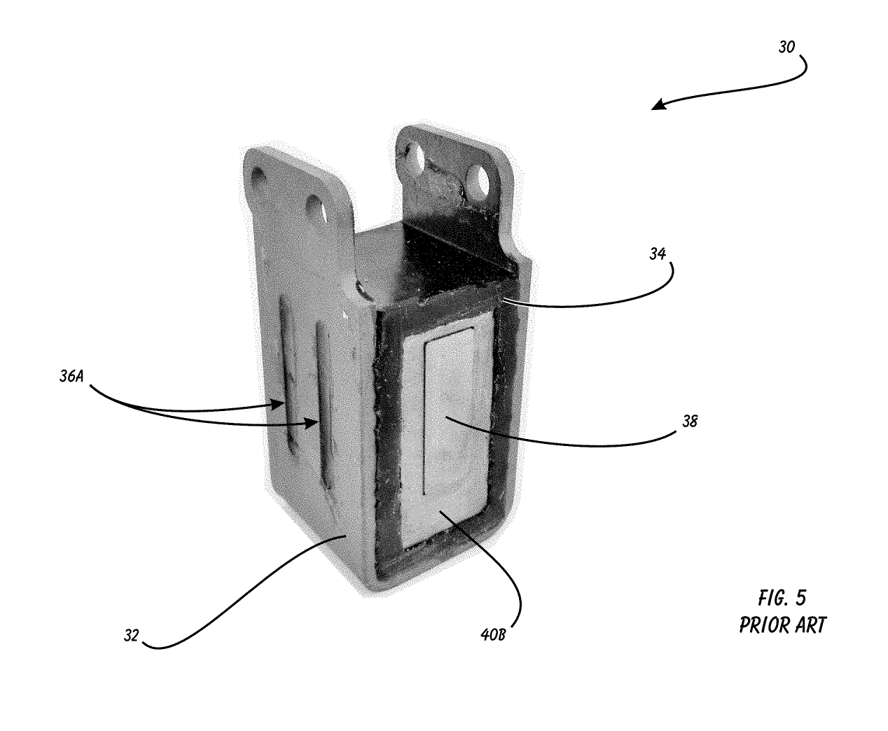

A second feature seen here is the inclusion of the front retention plate 40A. As shown, the head of the frame attachment element 38 protrudes through an aperture formed in the front retention plate 40A. The retention plate 40A serves to further bond with the interstitial element 34, while also stabilizing the restraining the frame attachment element 38 within the engine attachment frame 32. These two features, when combined with the use of urethane instead of rubber, serve to make the engine mount 30 substantially more durable and long-lasting. FIG. 5 shows the other side of the mount 30.

FIG. 5 is a rear perspective view of the element 30 (of the Parent Application) of FIG. 4. In this view, the urethane of the interstitial element 34 can be seen protruding into the pair of retaining apertures on this (opposing) side of the engine attachment frame 32. The frame attachment element 38 actually protrudes from the back side of the urethane interstitial element 34. Like the other end of the frame attachment element 38, the rear retention plate 40B is embedded in the urethane material in order to firmly secure the element 38 within the urethane.

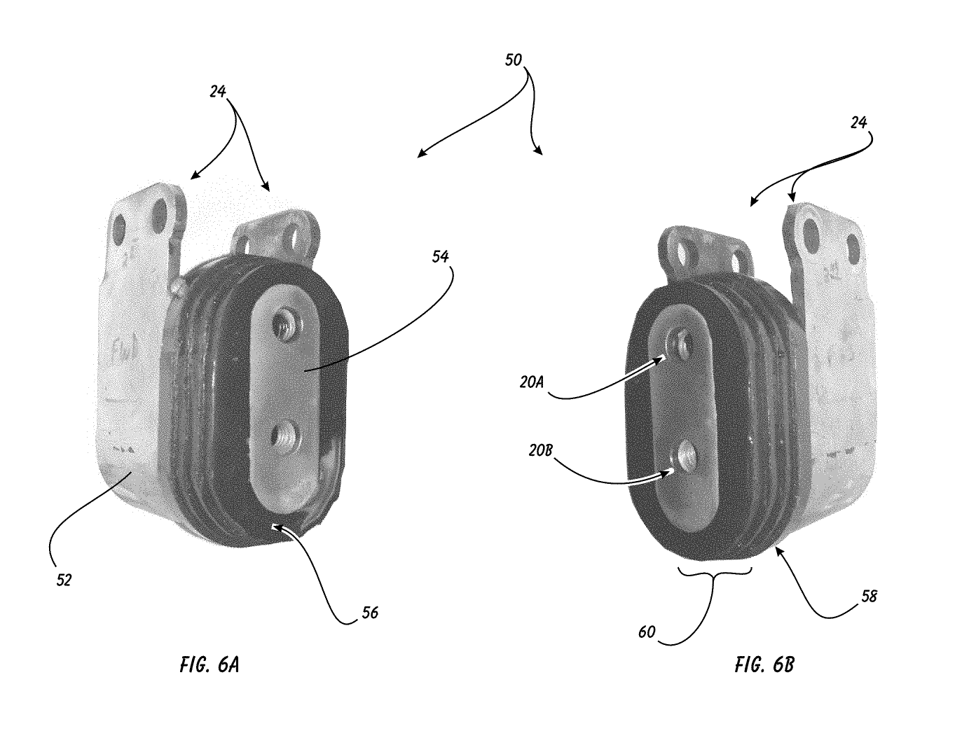

After substantial real-world use and testing of the element 30, Applicant determined that the performance remained inconsistent. While it was still vastly superior to the Original Equipment engine mount, it still tended to allow vibrations to pass from the engine to the frame. Consequently, a redesign of the device was undertaken. FIG. 6 provides additional detail of the resultant improved design.

The present invention can best be understood by consideration of FIGS. 6A and 6B. FIGS. 6A and 6B are front perspective views the Improved Engine Mount having Improved Stiffness and Exchangeability 50. There are several distinctions between this element 50 and the element [30] of the Parent Application. This mount 50 is oval in shape, rather than rectangular. There are no front and rear backing plates. A harder urethane material is used for this device (an 80 durometer reading, rather than a 55 durometer reading). A key difference is that the urethane intersitial element 56 is not bonded to the engine attachment frame 52, but rather is unattached to the frame 52 in any permanent way. As will be discussed further below, this lack of bonding between the elements means that the interstitial element 56 can be removed and replaced without the need to replace the entire mount 50.

The engine bolt bores 24 are located so that they correspond to the Harley Davidson original equipment engine. The engine attachment frame 52 now has an oval shape, rather than a rectangular shape (as both the OEM and the mount of the Parent Application had). It was determined that the oval shape provided more consistent, reliable cushioning and support for the engine in all 360 degrees of possible motion (i.e. vibration or torque-driven movement).

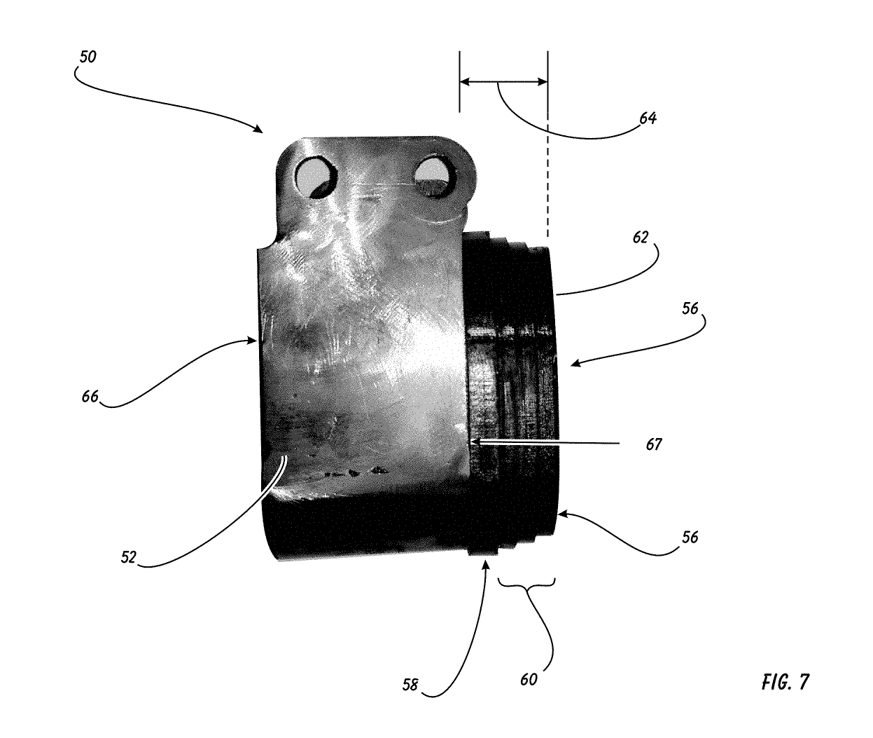

As is depicted in FIG. 6B, the frame attachment element 54 extends forward from the front of the engine attachment frame 52—this distance is effectively the same as with the device [30] of the Parent Application. What is different is that the frame attachment element 54 is not bare, unsupported metal in this extended portion. On the contrary, there is a tapered portion 60 of the interstitial element 56 that extends between the shoulder portion 58 (against the face of the frame 52) and the face of the frame attachment element 54. The tiered tapering of the urethane that makes up the interstitial element 56 results in a varying level of stiffness in the support provided by the interstitial element 56 to the frame attachment element 54 over the extent of the protruding element 54. As the distance from the shoulder portion 58 increases, the thickness of the urethane reduces, and the stiffness of the support also reduces. Testing has revealed that this geometry provides the benefit of reliable support for the frame attachment element 54, while also giving very good vibration isolation between the engine and frame. If we now turn to FIG. 7, we can continue to examine this improved system.

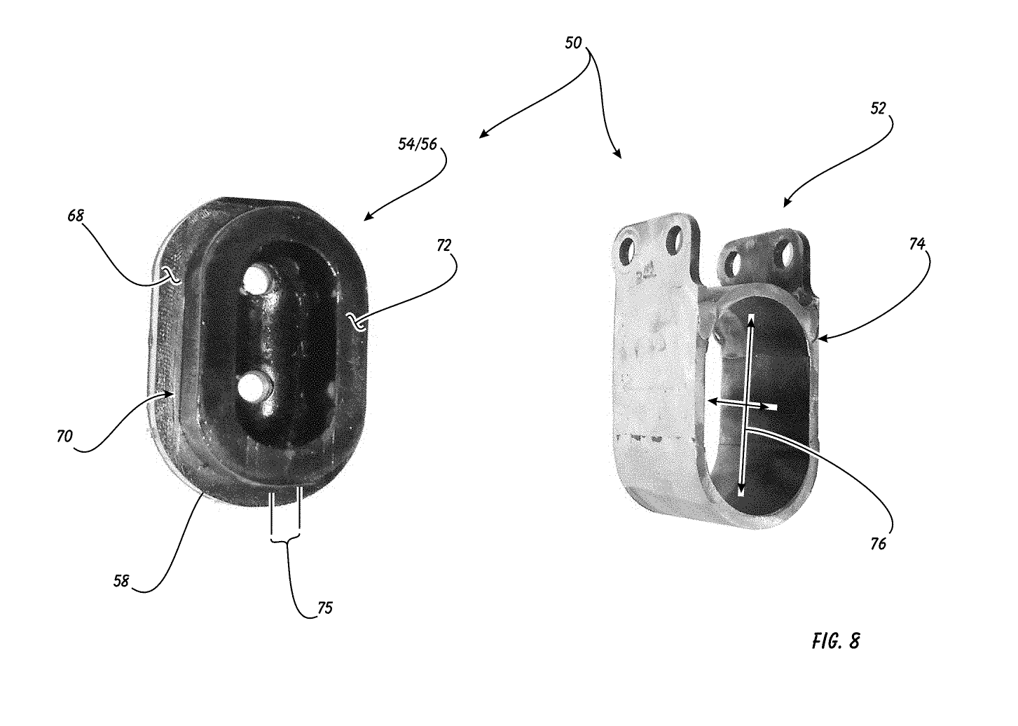

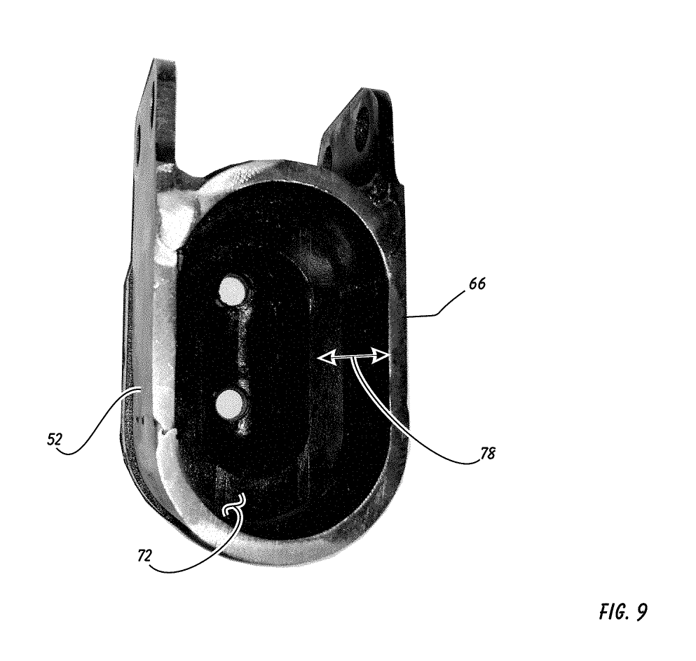

FIG. 7 is a side view of the Mount element 50 of FIGS. 6A and 6B. The frame element 52 is defined by a rear face 66 and a front face 67. The face 62 of the interstitial element 56 protrudes beyond the face 67 of the frame element 52 by extension distance 64. Over that distance, the outer perimeter of the interstitial element 56 tapers in a tiered manner, starting from the shoulder portion 58, through the tiered taper portion 60, and terminating at the face 62. Other unique aspects of the instant design are shown in FIGS. 8 and 9.

FIG. 8 is an exploded rear perspective view of the Mount element 50 of FIGS. 6A and 6B, and FIG. 9 is rear perspective view of the fully assembled mount element 50. The shoulder portion 58 has an outer diameter (around its oval shape) that is greater than the outer diameter of the perphery of the engine attachment frame element 52. Consequently, the shoulder portion 58 prevents the tapered portion [60] from being inserted into the central bore 74 of the frame element 52. The shoulder rear face 68 defines the surface where the diameter of the intersititial element 56 expands beyond the sidewall 70 of the internal portion of the interstitial element 56. The shape and outer diameter of the sidewall 70 is configured to cooperate with the central bore 74 of the frame element 52 so that the interstitial element 56 will slip into the central bore 74 until the shoulder rear face 68 reaches the frame front face [67]. At this point, as depicted in FIG. 9, the interstitial element 56 does not reach the rear face 66 of the frame element 52. Since the depth of the sidewall 70 of the captured portion 75 of the interstitial element 56 is less than the depth of the inner wall 76 of the central bore 74, a rear standoff distance 78 is left between the rear faces 66 and 72.

The rear standoff distance 78 between the rear faces 72 and 66 results in two benefits: (a) the interstitial element 54/56 can be more easily removed and re-inserted into the outer frame 52 because there is less friction between the inner wall [76] and the interstitial element sidewall [70]; and (b) the reduction in material results in a decrease in weight for the overall element [50].

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A device for interconnecting an engine to a vehicle frame, the device comprising:
an engine attachment frame formed with a central bore;
a frame attachment element located within said engine attachment frame in spaced relation thereto;
an interstitial element bonded to said frame attachment element, said interstitial element residing in, without being attached to, said engine attachment frame.

2. The device of claim 1, wherein said interstitial element comprises material having an A-scale durameter hardness rating of between 70 and 90.

3. The device of claim 1, wherein:
said engine attachment frame defines a engine frame front face;
said frame attachment element defines a frame element front face that is generally parallel to said front face, and protruding from said engine attachment frame; and
said interstitial element defines a portion extending beyond said engine frame front face and towards said frame element front face.

4. The device of claim 3, wherein said interstitial element defines a captured portion having a cross section that cooperates with said central bore of said engine attachment frame whereby said captured portion can be slipped into said central bore.

5. The device of claim 4, wherein said interstitial element further comprises a shoulder portion defining a cross section that is larger than the cross section of said central bore.

6. The device of claim 5, wherein said extending portion of said interstitial element commences at said shoulder portion and tapers to its point of termination.

7. The device of claim 6, wherein said portion extending beyond said engine frame front face extends from said shoulder portion and terminates at said frame element front face.

8. The device of claim 7, wherein said central bore defines a depth and said captured portion of said interstitial element defines a sidewall having a height that is less than said central bore depth, whereby a rear standoff distance is formed between a rear face of said engine attachment frame and a rear face of said sidewall.

9. A motorcycle engine mount assembly for interconnecting an engine to a motorcycle frame, comprising:
an engine attachment frame formed with a central bore defined by a front face and a rear face;
a frame attachment element located within said central bore, said frame attachment element defining an element front face and an element rear face, with said element front face protruding beyond said frame front face; and
an interstitial element filling the interstitial volume between said engine attachment frame and said frame attachment element and extending beyond said frame front face.

10. The assembly of claim 9, wherein said interstitial element comprises material having an A-scale durameter hardness rating of between 70 and 90.

11. The assembly of claim 9, wherein said interstitial element defines a captured portion having a generally oval cross section that cooperates with said central bore of said engine attachment frame whereby said captured portion can be slipped into said central bore.

12. The assembly of claim 11, wherein said interstitial element further comprises a shoulder portion defining a cross sectional diameter that is larger than the cross sectional diameter of said central bore.

13. The assembly of claim 12, wherein said extending portion of said interstitial element commences at said shoulder portion and tapers to its point of termination external to said central bore.

14. The assembly of claim 13, wherein said portion extending beyond said engine frame front face extends from said shoulder portion and terminates at said frame element front face.

15. The assembly of claim 14, wherein the cross-sectional diameter of said interstitial element adjacent to said frame element front face is greater than the cross sectional diameter of said captured portion.

16. The device of claim 11, wherein said central bore defines a depth and said captured portion of said interstitial element defines a sidewall having a height that is less than said central bore depth, whereby a rear standoff distance is formed between a rear face of said engine attachment frame and a rear face of said sidewall.
